(19) United States
(12) Patent Application Publication
(10) Pub. No.: US 2010/0284665 A1
(43) Pub. Date: Nov. 11, 2010

(54) Light Diffusing Safety Cap

(76) Inventor: Michael C. DOODY, Knoxville, TN (US)

Correspondence Address: PITTS AND BRITTIAN P C, P O BOX 51295, KNOXVILLE, TN, 37950-1295, US

(21) Appl. No.: 12/435,479

(22) Filed: May 5, 2009

(51) Int. Cl. G02B 6/00

(52) U.S. Cl. 385/147

(57) ABSTRACT

A light diffusing safety cap for use with a light guide that couples an endoscope to a high intensity light source is shown and described in detail herein. The light diffusing safety cap is coupled, in lieu of the endoscope, to the light guide. The high intensity light source emits a high intensity light, when activate, which is sufficient to cause thermal harm within a selected time. The light diffusing safety cap reduces the intensity of the high intensity light to inhibit thermal harm and emits the reduced intensity light to provide an indication that the high intensity light source is activate.

### CROSS-REFERENCE TO RELATED APPLICATIONS

Not Applicable

### STATEMENT REGARDING FEDERALLY-SPONSORED RESEARCH OR DEVELOPMENT

Not Applicable

### BACKGROUND OF THE INVENTION

1. Field of Invention

This invention relates to a safety cap for a light guide connected to a high intensity light source.

2. Description of the Related Art

An endoscope is a medical imaging device that allows a doctor to internally examine a patient. In modern endoscopes, the endoscope is attachable to a high intensity light source via a light guide, or a universal cord, that carries high intensity light produced by the external high intensity light source. These high intensity light sources vary in types and intensity, but generally the high intensity light sources can produce high intensity light having at least 150 watts and may exceed 300 watts.

The light guides are disconnectable from the endoscope and external high intensity light source such that each may be cleaned, stored, or transported. For subsequent use of the endoscope, the light guide must be re-connected to the high intensity light source and the endoscope. The safety problem occurs when one end of the light guide is connected to an activate high intensity light source while the other end is unconnected and emitting high intensity light.

This is a significant danger when the high intensity light emitting from the disconnected end of the light guide comes into contact with persons or inflammable materials within the surgery area, e.g. patients and drapes, for a selected period of time. Drapes and gowns, most likely being paper or fabric, are inflammable such that exposure to the high intensity light can ignite the drapes within seconds. Furthermore, a person exposed to the high intensity light in a concentrated area for a selected period can likely suffer thermal injuries. Noteably, patients under anesthesia are more likely to receive severe thermal injuries because they cannot move away from the high intensity light before they receive thermal injuries.

### BRIEF SUMMARY OF THE INVENTION

The safety problem occurs when the light guide is not attached to the endoscope wherein the light guide has a disconnected end that is frequently placed beside a patient or object within the surgical area. When the high intensity light source is activate the light guide emits high intensity light from the disconnected end in a small concentrated area such that the high intensity light is sufficient for thermal injury to a person and combustion of inflammable materials (hereinafter collectively referred to as “thermal harm”).

To reduce the likelihood of the light guide causing thermal harm, the light diffusing safety cap is releasably coupled to the light guide when the endoscope is disconnected. The light diffusing safety cap is compact and can be attached to the light guide prior to delivery such that the light diffusing safety cap is coupled to prevent hazards. The light diffusing safety cap has a diffusing member for receiving the high intensity light from the first end of the light guide and then reducing the intensity thereof. In one embodiment, the diffusing member includes a material to diffuse the high intensity light and emits the reduced intensity light. In one embodiment, the diffusing member includes a material that absorbs high intensity light to reduce the intensity thereof. In another embodiment, the diffusing member has a wall defining a cavity within the diffusing member. The cavity is selectively arranged such that high intensity light is diffused along the cavity.

Reducing the intensity of the high intensity light, whether by diffusing or absorbing, causes a reduced intensity light to be emitted from the light diffusing safety cap that provides a notification of a potential safety hazard. The reduced intensity light is safe for contact with things or persons within the surgery area, e.g. drapes and patients. The light diffusing safety cap reduces the likelihood igniting drapes or other inflammable materials and the likelihood of a person suffering burns in the event of inadvertent contact with the high intensity light. Additionally, the diffusing member illuminates for further reducing the likelihood of exposing the unconnected end of the light guide such that high intensity light is emitted causing a safety hazard.

### BRIEF DESCRIPTION OF THE SEVERAL VIEWS OF THE DRAWINGS

The above-mentioned features of the invention will become more clearly understood from the following detailed description of the invention read together with the drawings in which:

FIG. 1 illustrates an endoscopy system using one embodiment of the light diffusing safety cap releasably coupled to a light guide;

FIG. 2 is a perspective view of one embodiment of the light diffusing safety cap releasably coupled to a light guide;

FIG. 3 is a sectional view of one embodiment of the light diffusing safety cap releasably coupled to a light guide as illustrated in FIG. 2;

FIG. 4 is a perspective view of one embodiment of the light diffusing safety cap;

FIG. 5 is a sectional view of one embodiment of the light diffusing safety cap releasably coupled to a light guide as illustrated in FIG. 4;

FIG. 6 is a sectional view of one embodiment of the light diffusing safety cap releasably coupled to a light guide as illustrated in FIG. 4;

FIG. 7 is a sectional view of one embodiment of the light diffusing safety cap releasably coupled to a light guide as illustrated in FIG. 4;

FIG. 8 is a sectional view of an alternate embodiment of the light diffusing safety cap releasably coupled to a light guide as illustrated in FIG. 4;

FIG. 9 is a sectional view of an alternate embodiment of the light diffusing safety cap releasably coupled to a light guide as illustrated in FIG. 4; and

FIG. 10 is a sectional view of an alternate embodiment of the light diffusing safety cap releasably coupled to a light guide as illustrated in FIG. 4.

### DETAILED DESCRIPTION OF THE INVENTION

A light diffusing safety cap for use with a light guide that couples an endoscope to a high intensity light source is shown and described in detail herein. The light diffusing safety cap is coupled, in lieu of the endoscope, to the light guide. The high intensity light source emits a high intensity light, when activate, which is sufficient to cause thermal harm within a selected time. The light diffusing safety cap reduces the intensity of the high intensity light to inhibit thermal harm and emits the reduced intensity light to provide an indication that the high intensity light source is activate.

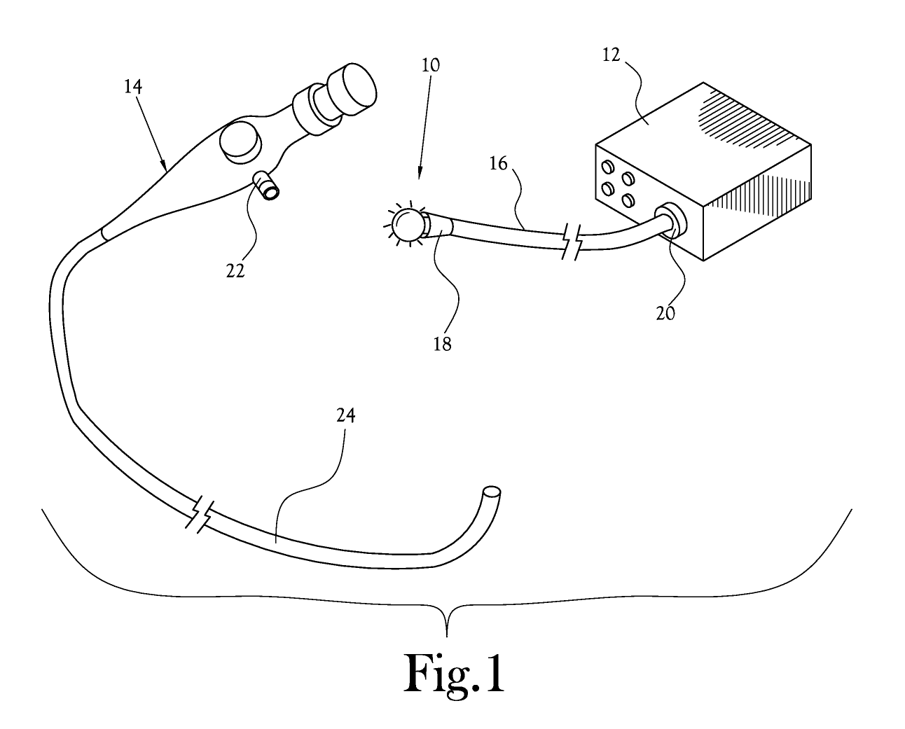

FIG. 1 illustrates an endoscopy system using one embodiment of the light diffusing safety cap illustrated generally at 10. The endoscopy system includes a high intensity light source 12, an endoscope 14, and a light guide 16 configured to couple the endoscope 14 to the high intensity light source 12. A first end of the light guide has a first connector 18 configured to connect to an endoscope and a second end of the light guide has a second connector 20 is configured to connect to a high intensity light source 12. The endoscope 14 having a light-input connector 22 coupleable with the first connector 18 of the light guide 16 and an insertion tube 24 to be inserted within a body to view an illuminated area. The high intensity light source 12 capable of emitting a high intensity light sufficient to cause thermal harm within a selected time. The amount of time that must occur before thermal harm occurs varies with the intensity. At typical operating intensities, the high intensity light is capable of rapidly causing thermal harm. In fact, thermal harm can occur within seconds.

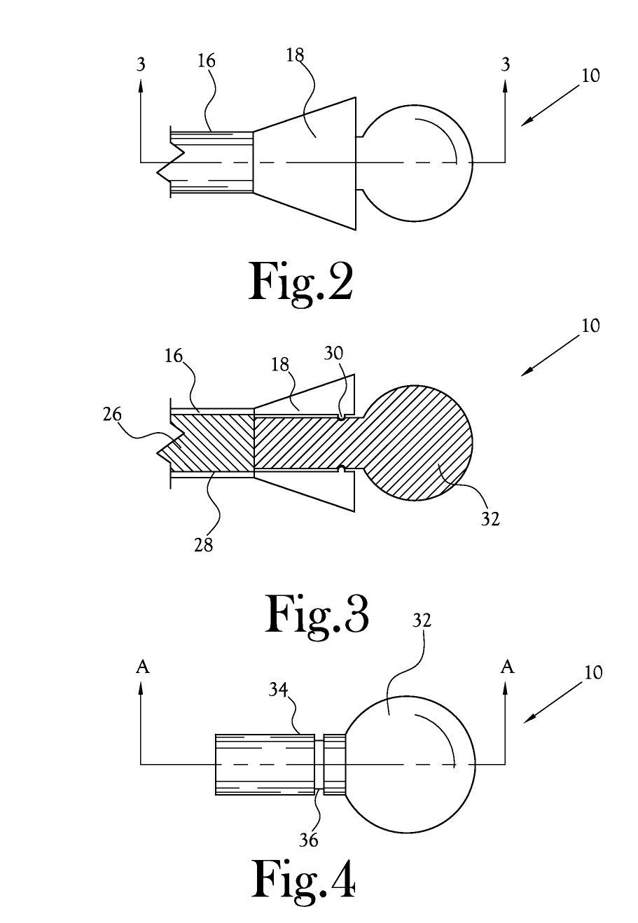

FIG. 2 illustrates one embodiment of the light diffusing safety cap 10 coupled to the light guide 16. In the illustrated embodiment, a portion of the light diffusing safety cap 10 is received in the first connector 18 such that the light diffusing safety cap 10 is coupled within the light guide 16.

FIG. 3 illustrates a sectional view of one embodiment of the light diffusing safety cap 10 coupled to a light guide 16 for demonstrative purposes. As is apparent from the sectional view, the light guide 16 includes an optical medium 26 through which optical communication occurs. For example, this optical medium 26 can be glass fibers, plastic, or other optical materials. The light guide 16 has a jacket 28 to protect the optical medium 26 from breakage and to aid in reflection such that losses associated with optical communication are reduced. Furthermore, the light guide 16 has a first connector 18 that allows for releasably coupling with the light guide 16. Typically the endoscope is coupled to the light guide 16 wherein the light-input connector 22 is received within the first connector 18 of the light guide 16 such that the circumferential lip 30 engages the groove on the light-input connector 22 and thereby couples the endoscope 14 to the light guide 16.

The light diffusing safety cap 10 is releasably coupleable to the first connector 18 of the light guide 16 such that light is transmitted there between. In the illustrated embodiment, the light diffusing safety cap 10 is configured much akin to the light-input connector 22 of the endoscope 14. In the illustrated embodiment, the light diffusing safety cap 10 is releasably coupleable to the first connector 18 of the light guide 16 such that a portion of the light diffusing safety cap 10 is disposed proximate to the optical medium 26. This allows for the high intensity light to be transferred from the optical medium 26 into the light diffusing safety cap 10. In the illustrated light guide 16, the high intensity light travels within the optical medium 26 such that the high intensity light does not travel normal (perpendicular) to the light diffusing safety cap 10. More specifically, the high intensity light encounters the light diffusing safety cap 10 at a plurality of angles of incidence such that any space between the optical medium 26 and light diffusing safety cap 10 can result in reflection of the high intensity light into the optical medium 26. Therefore, as shown in the illustrated embodiment, the light diffusing safety cap 10 and the optical medium 26 are abutting such that reflection of the high intensity light into the optical medium 26 is reduced.

The light diffusing safety cap 10 reduces the intensity of the high intensity light such that such thermal harm is inhibited and emits a reduced intensity light that provides an indication that the high intensity light source 12 is active. In one embodiment, the light diffusing safety cap 10 reduces the intensity of the high intensity light by diffusing the light. The light diffusing safety cap 10 includes a diffusing member 32 for reducing the intensity of the light. In the illustrated embodiment, the diffusing member 32 is a translucent material that diffuses the high intensity light. In one embodiment, the diffusing member 32 comprises a translucent plastic which diffuses the high intensity light and also absorbs a portion of high intensity light further reducing the intensity thereof. In another embodiment, the diffusing member 32 comprises a transparent material, such as Pyrex glass, that is frosted to diffuse the high intensity light such that a selected amount of high intensity light passes through the diffusing member 32. The reduced intensity light is thereafter emitted from the light diffusing safety cap 10. Additionally, in one embodiment of the light diffusing safety cap 10 emissions of reduced intensity light provide an indication that the high intensity light source 12 is active. In another embodiment, the light diffusing safety cap 10 provides an indication by the diffusing member 32 absorbing a portion of the light such that the diffusing member 32 “glows” from the absorbed light.

FIG. 4 illustrates one embodiment of the light diffusing safety cap 10 having a diffusing member 32 and mounting member 34. The mounting member 34 is configured such that the mounting member 34 is releasably coupleable to the first connector 18 of the light guide 16. More specifically, the mounting member 34 has a groove 36 about the mounting member 34 that is engaged by the circumferential lip 30 when the mounting member 34 is received by the first connecter 18 of the light guide 16. The diffusing member 32 is configured such that when coupled to the light guide 16 the diffusing member 32 is in optical communication with the high intensity light source 12. It should be noted, that the diffusing member 32 can be any shape, although shown as spherical in the illustrated Figures, including, but not limited to, conical, square, partially spherical, or other orientation such that the diffusing member 32 can reduce the intensity of the high intensity light. In alternate embodiments, the diffusing member 32 and mounting member 34 can be one piece, respective pieces, or otherwise be arranged for reducing the intensity of the high intensity light when releasably coupling to a light guide 16.

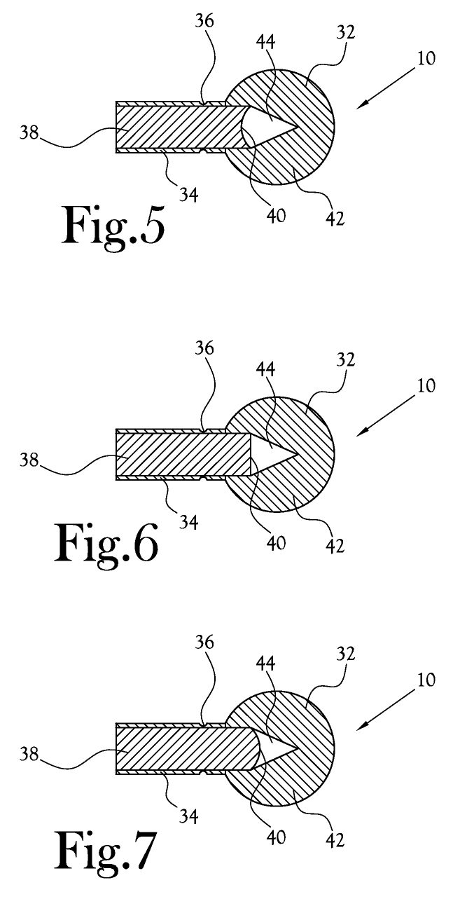

FIGS. 5-7 illustrate embodiments of a sectional view at A in one embodiment of the light diffusing safety cap 10. The light diffusing safety cap 10 is releasably coupleable with a light guide 16 to reduce the intensity of the high intensity light such that such thermal harm is inhibited and said light diffusing safety cap 10 provides an indication that high intensity light is being received by the light diffusing safety cap 10. In the illustrated embodiments, the light diffusing safety cap 10 includes a mounting member 34, a cylindrical member 38, and a diffusing member 32.

The mounting member 34 releasably couples the light diffusing safety cap 10 with the light guide 16. In the illustrated embodiments, the mounting member 34 being a cylindrically hollow member receivable within the first connector 18 of the light guide 16. The mounting member 34 being receivable within the first connector 18 of the light guide 16 such that circumferential lip 30 engages the groove 36 of the mounting member 34 and thereby releasably coupling the light diffusing safety cap 10 to the light guide 16. In alternate embodiments, the light diffusing safety cap 10 is otherwise disposed proximate to the end of the light guide 16 without departing from the spirit and scope of the present invention.

The cylindrical member 38 is securable within the mounting member 34 such that light emitted by the light guide 16 is received by the cylindrical member 38 which transfers the light to the diffusing member 32. In the illustrated embodiments, the cylindrical member 38 is a transparent material such that light passes, relatively unaffected, into the diffusing member 32. Furthermore, the cylindrical member 38 defines a lens 40 for defining how the high intensity light passes into the diffusing member 32. In the illustrated embodiment, the lens 40 is selected from concave (FIG. 5), flat (FIG. 6), or convex (FIG. 7) such that light is focused or spread upon entering the diffusing member 32. In alternative embodiments, the lens 40 can be frosted such that the intensity of high intensity light is further reduced upon entering the diffusing member 32.

The diffusing member 32 reduces the high intensity light such that reduced intensity light is emitted from the diffusing member 32. The diffusing member 32 is releasably coupled with the cylindrical member 38 such that high intensity light from the light guide 16 is transferred through the cylindrical member into the cavity of the diffusing member 32. In the illustrated embodiment, the diffusing member 32 is generally translucent and has a wall 42 defining a cavity 44 within the diffusing member 32. The cavity 44 is selectively arranged such that high intensity light is diffused along the cavity 44. In the illustrated embodiment, the cavity 44 is conically shaped such that high intensity light from the cylindrical member 38 enters the cavity 44 through the cone's base and travels outward. As the high intensity light progresses through the cavity 44 the high intensity light impacts the wall 42, of the diffusing member 32, along the locus of the cavity 44 such that rays of light are scattered outward through the wall 42 in multiple directions and thereby emitting reduced intensity light. In alternate embodiments, the diffusing member 32 can reduce the intensity of the high intensity light in ways other than those described above without departing from the spirit and scope of the present invention.

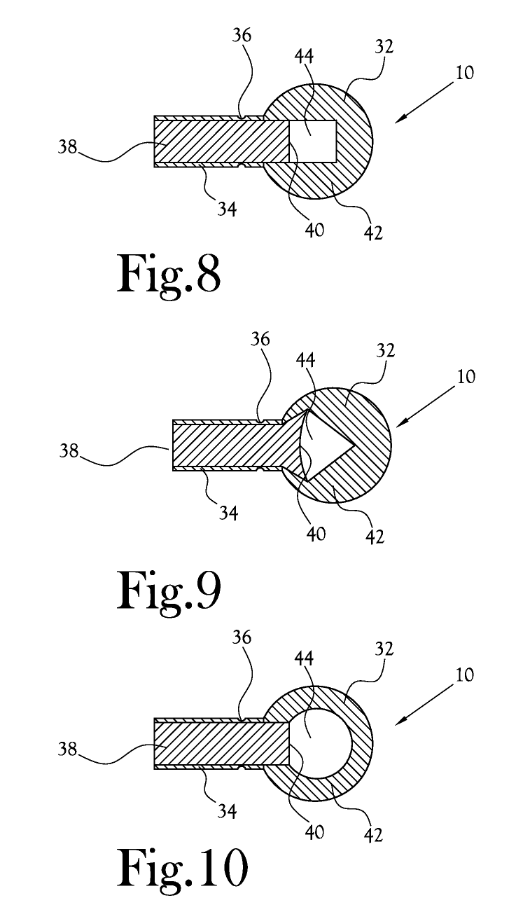

FIG. 8 illustrates an alternate embodiment of a sectional view at A in one embodiment of the light diffusing safety cap 10. The cylindrical member 16 has a flat lens 40 being frosted such that reduced intensity light passes into the diffusing member 32. The diffusing member 32 being translucent and absorbing and having a wall 32 that defines a cubic cavity 44 within the diffusing member 32. The cavity 44 and wall 42 contribute to reduction of the light intensity. In an alternate embodiment, the cylindrical member 38 is receivable within the diffusing member 32 such that the cylindrical member 38 occupies the shown cavity 44. More specifically, the cylindrical member 38 is inserted into the diffusing member 32 and bonded by thermally annealing the cylindrical member 38 to the diffusing member 32.

FIG. 9 illustrates an alternate embodiment of a sectional view at A in one embodiment of the light diffusing safety cap 10. The cylindrical member 38 has a concave lens 40 through which light passes into a conical cavity 44 within the diffusing member 32. The lens 40 of the cylindrical member 38 is flared outward to capture additional high intensity light for focusing into the cavity 44.

FIG. 10 illustrates an alternate embodiment of a sectional view at A in one embodiment of the light diffusing safety cap 10. The cylindrical member 38 has a flat lens 40 through which high intensity light rays pass into a spherical cavity 44 within the diffusing member 32. As the high intensity light progresses through the cavity 44 rays of high intensity light impact the wall 42, of the diffusing member 32, along the curvature of the cavity 44 such that the rays of high intensity light are scattered outward through the wall 42 of the diffusing member 32 in multiple directions and thereby emitting reduced intensity light.

While the present invention has been illustrated by description of several embodiments and while the illustrative embodiments have been described in considerable detail, it is not the intention of the applicant to restrict or in any way limit the scope of the appended claims to such detail. Additional advantages and modifications will readily appear to those skilled in the art. The invention in its broader aspects is therefore not limited to the specific details, representative apparatus and methods, and illustrative examples shown and described. Accordingly, departures may be made from such details without departing from the spirit or scope of applicant's general inventive concept.

What is claimed is:

1. A light diffusing safety cap for use with a light guide having a first end and a second end, the first end configured to connect to a endoscope, the second end configured to connect to a high-intensity light source, when active the high intensity light source emits a first intensity light sufficient to cause thermal injury to a person or combustion of inflammable materials, said light diffusing safety cap comprising:
a diffusing member comprising a body having at least a portion adapted to be releasably coupleable to the first end of an light guide when the endoscope is not attached to the light guide, said diffusing member is adapted to receive the first intensity light and reduce the first intensity light to a second intensity light to inhibit thermal injury to a person or combustion of inflammable materials for a selected period, said diffusing member adapted to emit said second intensity light to provide an indication that the high intensity light source is active, whereby the light diffusing cap emits said second intensity light that provides said indication while inhibiting thermal injury to a person or combustion of inflammable materials for a selected period.

2. The light diffusing safety cap of claim 1 wherein said diffusing member comprises at least one layer being a translucent material to diffuse the first intensity light.

3. The light diffusing safety cap of claim 1 wherein said diffusing member comprising at least one layer adapted to absorb a portion of the first intensity light.

4. The light diffusing safety cap of claim 1 wherein said diffusing member comprising a coating adapted to reduce the intensity of the first intensity light.

5. The light diffusing safety cap of claim 1 wherein said diffusing member further comprising a wall that defines an internal cavity, the high intensity light being received into said internal cavity, said internal cavity is adapted to diffuse the first intensity light, whereby first intensity light enters and progresses through the internal cavity where the first intensity light impacts said wall such that rays of light are scattered outward through the wall and thereby emitting the second intensity light.

6. The light diffusing safety cap of claim 5 wherein said internal cavity being a conical shape tapered away from the first end of the light guide.

7. A light diffusing safety cap for use with a light guide having a first and a second end, the first end configured to connect to a endoscope, the second end configured to connect to a high-intensity light source, when active the high intensity light source emits a first intensity light sufficient to cause thermal injury to a person or combustion of inflammable materials, said light diffusing safety cap comprising:
a mounting member having a body adapted to be releasably coupleable to the first end of the light guide when the endoscope is not attached to the light guide; and
a diffusing member carried by said mounting member such that said diffusing member is adapted to receive the first intensity light and reduce the first intensity light to a second intensity light to inhibit thermal injury to a person or combustion of inflammable materials for a selected period, said diffusing member adapted to emit said second intensity light to provide an indication that the high intensity light source is active, whereby the light diffusing cap emits said second intensity light that provides said indication while inhibiting thermal injury to a person or combustion of inflammable materials for a selected period.

8. The light diffusing safety cap of claim 7 wherein said diffusing member and said mounting member are integrally formed such that said diffusing member and said cylindrical member are a unitary body.

9. The light diffusing safety cap of claim 7 wherein said diffusing member comprising at least one layer being a translucent material to diffuse the first intensity light.

10. The light diffusing safety cap of claim 7 wherein said diffusing member comprising at least one layer adapted to absorb a portion of the first intensity light.

11. The light diffusing safety cap of claim 7 wherein said diffusing member comprising a coating adapted to reduce the intensity of the first intensity light.

12. The light diffusing safety cap of claim 7 wherein said diffusing member further comprising a wall that defines an internal cavity, the first intensity light being received into said internal cavity, said internal cavity is adapted to diffuse the first intensity light, whereby first intensity light enters and progresses through the internal cavity where the first intensity light impacts said wall such that rays of light are scattered outward through the wall and thereby emitting the second intensity light.

13. A light diffusing safety cap for use with a light guide having a first end and a second end, the first end configured to connect to a endoscope, the second end configured to connect to a high-intensity light source, when active the high intensity light source emits a first intensity light sufficient to cause thermal injury to a person or combustion of inflammable materials, said light diffusing safety cap comprising:
a mounting member configured to be releasably coupleable to the first end of the light guide when the endoscope is not attached to the light guide;
a cylindrical member having a first end and a second end, said cylindrical member being carried by said mounting member such that said first end of said cylindrical member is adapted to receive the first intensity light and emit a second intensity light from said second end of said cylindrical member; and
a diffusing member carried by said mounting member such that said diffusing member is adapted to receive the second intensity light and reduce said second intensity light to a third intensity light to inhibit thermal injury to a person or combustion of inflammable materials for a selected period, said diffusing member adapted to emit said third intensity light to provide an indication that the high intensity light source is active, whereby the light diffusing cap emits said third intensity light that provides said indication while inhibiting thermal injury to a person or combustion of inflammable materials for a selected period.

14. The light diffusing safety cap of claim 13 wherein said diffusing member comprising at least one layer being a translucent material to diffuse the second intensity light.

15. The light diffusing safety cap of claim 13 wherein said diffusing member comprising at least one layer adapted to absorb a portion of the second intensity light.

16. The light diffusing safety cap of claim 13 wherein said diffusing member comprising a coating adapted to reduce the intensity of the second intensity light.

17. The light diffusing safety cap of claim 13 wherein said diffusing member further comprising a wall that defines an internal cavity, the second intensity light being received into said internal cavity, said internal cavity is adapted to diffuse the second intensity light, whereby second intensity light enters and progresses through the internal cavity where the second intensity light impacts said wall such that rays of light are scattered outward through the wall and thereby emitting the third intensity light.

18. The light diffusing safety cap of claim 13 wherein said cylindrical member comprising at least one layer being a translucent material adapted to diffuse the first intensity light.

19. The light diffusing safety cap of claim 13 wherein said cylindrical member adapted with a coating to diffuse the first intensity light.

20. The light diffusing safety cap of claim 13 wherein said second end of said cylindrical member defining a lens having a selected curvature, said lens is adapted to receive and allow passage of the first intensity light into said diffusing member, whereby the curvature of the lens directs the first intensity light into said cavity of said diffusing member for diffusing the rays of light.
